(19) United States
(12) Patent Application Publication
(10) Pub. No.: US 2015/0236392 A1
(43) Pub. Date: Aug. 20, 2015

(54) BAND-PASS FILTER

(71) Applicant: NEC CORPORATION, Minato-ku, Tokyo (JP)

(72) Inventor: Daisuke Iwanaka, Tokyo (JP)

(73) Assignee: NEC CORPORATION, Tokyo (JP)

(21) Appl. No.: 14/426,717

(22) PCT Filed: Sep. 4, 2013
(86) PCT No.: PCT/JP2013/005217

§ 371 Date: Mar. 6, 2015

(30) Foreign Application Priority Data
Sep. 7, 2012 (JP) 2012-196858

(51) Int. Cl. H01P 1/207

(52) U.S. Cl. CPC H01P 1/207

(57) ABSTRACT

A band-pass filter of the present invention is a band-pass filter provided with rectangular waveguides separated from each other along a middle of a broad width surface of the filter, and a metal plate interposed between the rectangular waveguides, wherein at least one of coupling plates formed of the metal plate is cut. Accordingly, it is possible to implement a band-pass filter having an increased range of values of the implementable coupling coefficient, and a wide bandwidth requiring a high coupling coefficient.

### TECHNICAL FIELD

The present invention relates to a fin-line band-pass filter having a wide selection for the band such as a microwave band or a millimeter wave band.

### BACKGROUND ART

As a band-pass filter for use in a microwave band or the like, a waveguide filter is preferably used. The waveguide filter has a low loss performance, and has high power durability suitable for applying large amount of electric power so that the waveguide filter is widely used in communication devices such as a base station device.

An example of a waveguide filter is a fin-line band-pass filter. The filter is a band-pass filter provided with rectangular waveguides separated from each other along a middle of a broad width surface of the filter, and a thin metal plate interposed between the rectangular waveguides and designed to resonate at a predetermined frequency. The metal plate can be manufactured with high precision by etching or pressing. Therefore, it is possible to secure the characteristics simply by assembling, without adjusting the characteristics by using a screw. Thus, the filter has an advantage that it is possible to remarkably shorten the assembling time and the inspection time.

### CITATION LIST

### Patent Literature

[PTL 1] International Patent Publication No. 2010/073554

### SUMMARY OF INVENTION

### Technical Problem

A fin-line band-pass filter has a feature that a resonant frequency and a coupling coefficient are determined by a thin metal plate to be interposed. However, a well-known fin-line filter fails to secure a sufficient coupling coefficient, and is difficult to be used in a wide bandwidth or in a very high frequency band such as a millimeter wave band (see PTL 1).

Further, in view of the manufacturing constraints on the thickness of a thin metal plate, it is difficult to manufacture a thin metal plate beyond a predetermined value. Therefore, as the size of a waveguide decreases in order to handle a millimeter wave band or the like, the ratio of a metal plate increases, which may result in further lowering the implementable coupling coefficient. Therefore, in particular, when applying to high frequency such as a millimeter wave band, a fin-line filter is difficult to be used.

In view of the above, an object of the present invention is to provide a fin-line band-pass filter provided with rectangular waveguides separated from each other along a middle of a broad width surface of the filter, and a thin metal plate interposed between the rectangular waveguides and designed to resonate at a predetermined frequency, wherein the band-pass filter has an increased range of values of the implementable coupling coefficient, and a wide bandwidth requiring a high coupling coefficient.

### Solution to Problem

An aspect of the invention is directed to a band-pass filter provided with rectangular waveguides separated from each other along a middle of a broad width surface of the filter, and a metal plate interposed between the rectangular waveguides, wherein at least one of coupling plates formed of the metal plate is cut.

### Advantageous Effects of Invention

According to a fin-line band-pass filter of the present invention, it is possible to implement a band-pass filter having an increased range of values of the implementable coupling coefficient, and a wide bandwidth requiring a high coupling coefficient.

### BRIEF DESCRIPTION OF DRAWINGS

FIG. 1 is an exploded perspective view of a fin-line band-pass filter of an exemplary embodiment of the present invention;

FIG. 2 is a perspective view of the fin-line band-pass filter after assembling of the exemplary embodiment of the present invention;

FIG. 3 is an exploded perspective view of a fin-line band-pass filter of an existing embodiment;

FIG. 4A is a diagram illustrating a structure of a metal plate of the fin-line band-pass filter of the exemplary embodiment of the present invention;

FIG. 4B is a diagram illustrating a structure of a metal plate of an existing fin-line band-pass filter;

FIG. 5 is a diagram illustrating a relationship between a ripple band and a coupling coefficient k;

FIG. 6 is a diagram illustrating a relationship between the width W of a coupling plate, and the coupling coefficient k;

FIG. 7 is a diagram illustrating a relationship between a gap D between coupling plate portions, and the coupling coefficient k;

FIG. 8 is a diagram illustrating characteristics of the fin-line band-pass filter of the exemplary embodiment;

FIG. 9A is a diagram illustrating a structure of a coupling plate of the fin-line band-pass filter of the exemplary embodiment;

FIG. 9B is a diagram illustrating a structure of a coupling plate of the fin-line band-pass filter of the exemplary embodiment;

FIG. 9C is a diagram illustrating a structure of a coupling plate of the fin-line band-pass filter of the exemplary embodiment;

FIG. 9D is a diagram illustrating a structure of a coupling plate of the fin-line band-pass filter of the exemplary embodiment;

FIG. 10 is an exploded perspective view of the fin-line band-pass filter of the exemplary embodiment of the present invention;

FIG. 11 is an exploded perspective view of a duplexer incorporated with the fin-line band-pass filter of the exemplary embodiment of the present invention; and

FIG. 12 is an exploded perspective view of the fin-line band-pass filter of the exemplary embodiment of the present invention.

### DESCRIPTION OF EMBODIMENTS

Hereinafter, a most preferred exemplary embodiment of the present invention is described in detail referring to the drawings. The exemplary embodiment described in the following includes technically preferred features in order to carry out the present invention, but the scope of the invention is not limited by the following description.

### (Description of Structure)

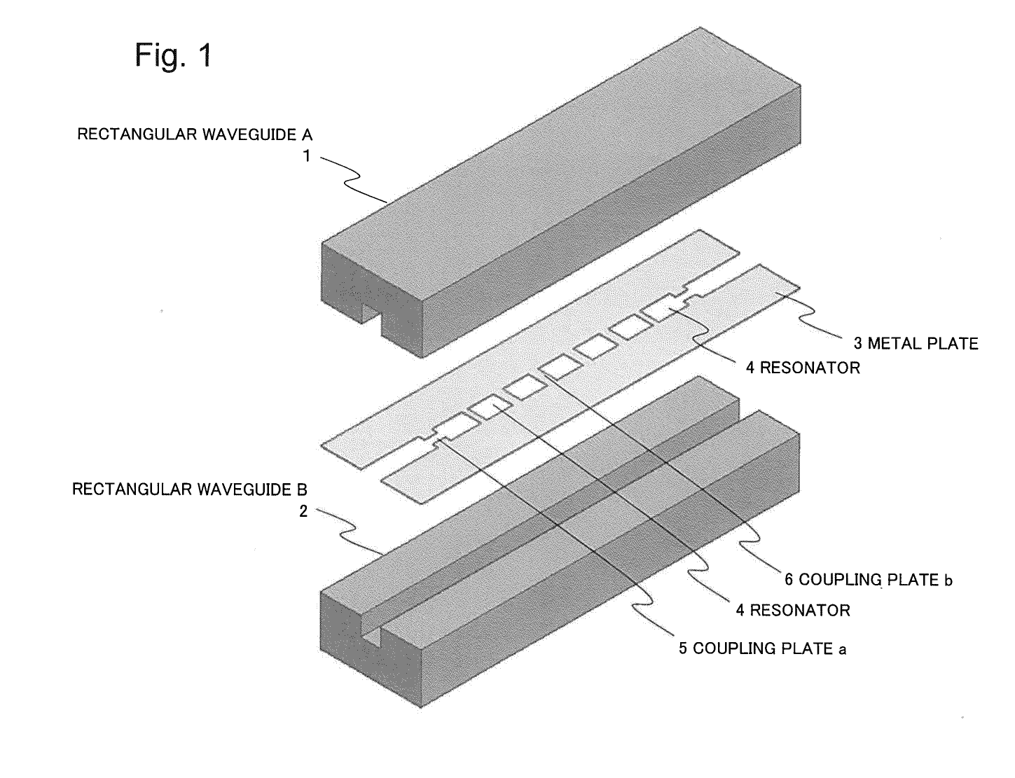

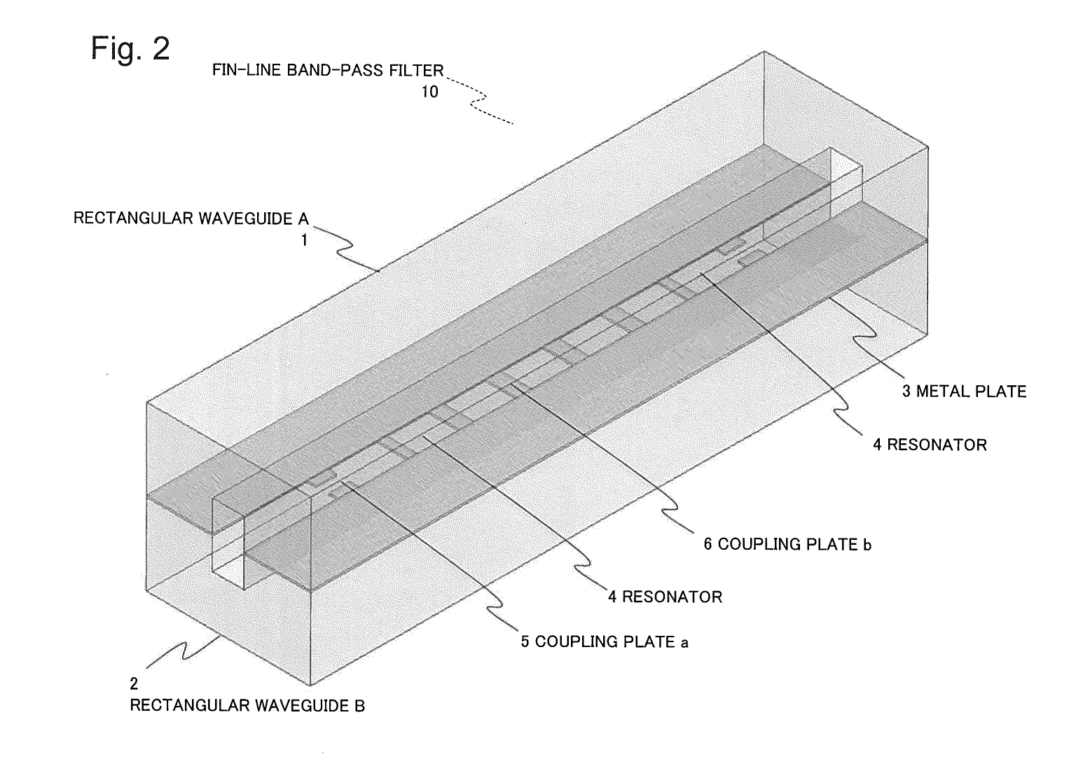

FIG. 1 is an exploded perspective view of a fin-line band-pass filter 10 of an exemplary embodiment of the present invention. FIG. 2 is a perspective view of the fin-line band-pass filter after assembling. The fin-line band-pass filter 10 includes rectangular waveguides A1 and B2 separated from each other along a middle of a broad width surface of the filter, and a thin metal plate 3 interposed between the rectangular waveguides A1 and B2 and designed to resonate at a predetermined frequency.

Cutting a coupling plate that determines the coupling between a resonator 4 and an external portion makes it possible to strengthen the coupling between the resonator 4 and the external portion, and to implement a coupling coefficient required for obtaining intended characteristics. In this example, a coupling plate that is cut is called as a coupling plate a5, and a coupling plate that is not cut is called as a coupling plate b6. In FIG. 1 and FIG. 2, only a first coupling plate and a last coupling plate are cut among all the coupling plates including the first coupling plate and the last coupling plate. Alternatively, a coupling plate or plates other than the first coupling plate and the last coupling plate may be cut depending on a required coupling coefficient.

### (Description of Operation)

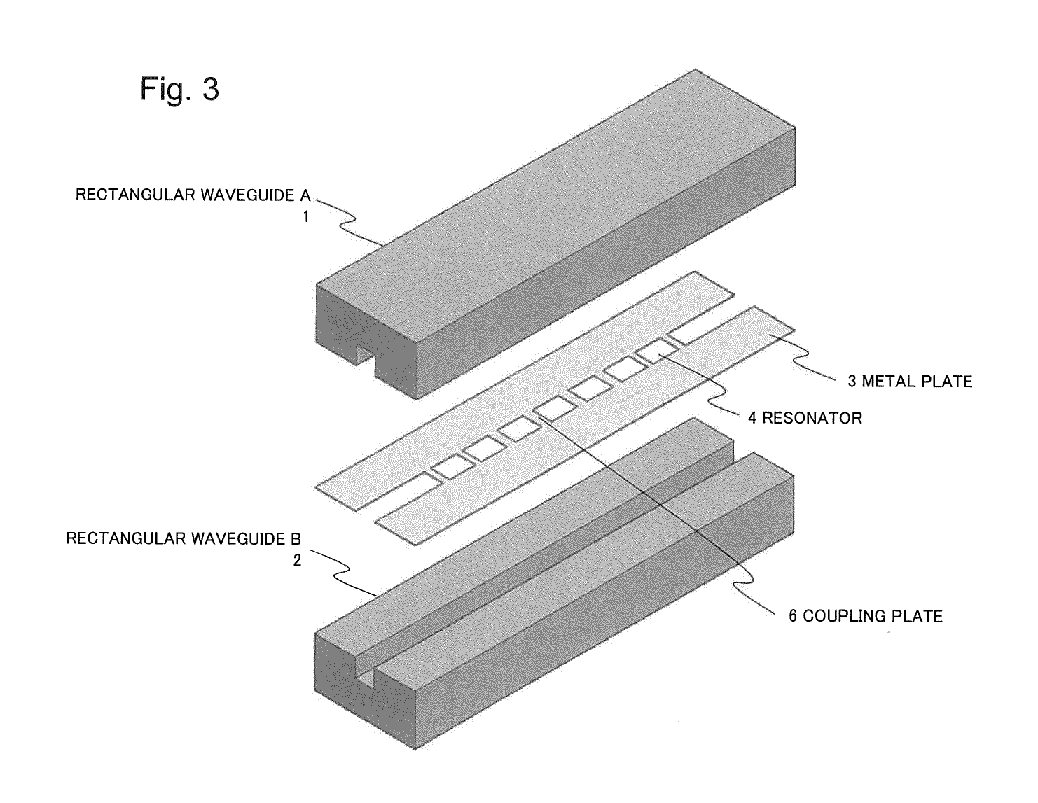

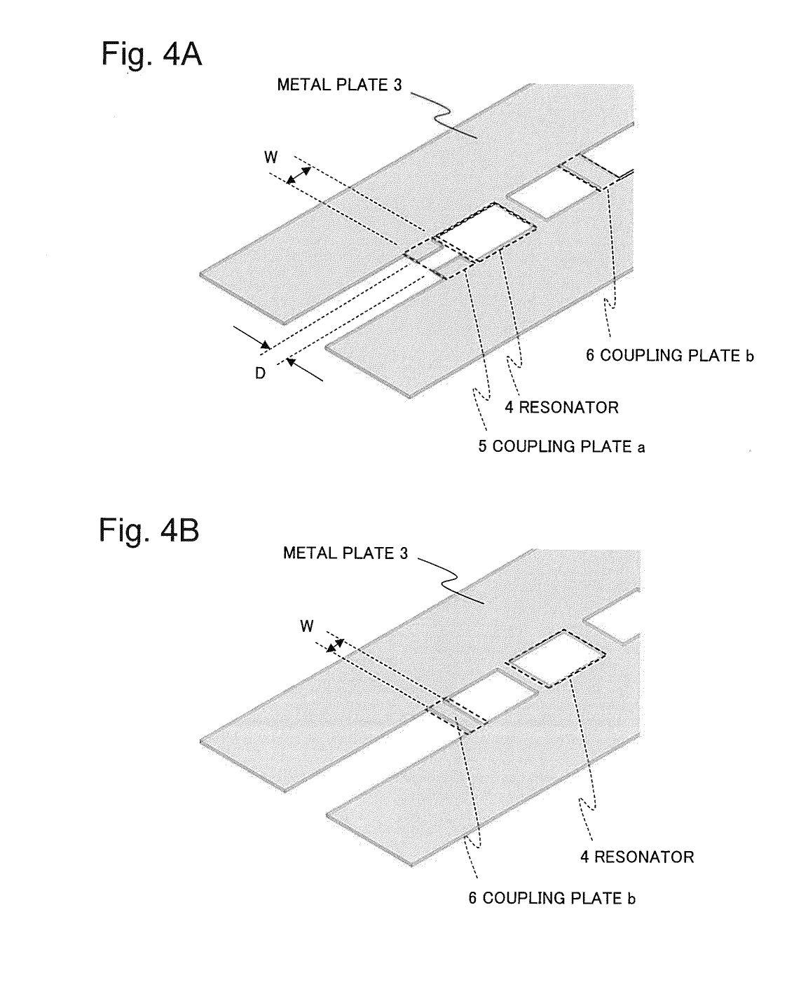

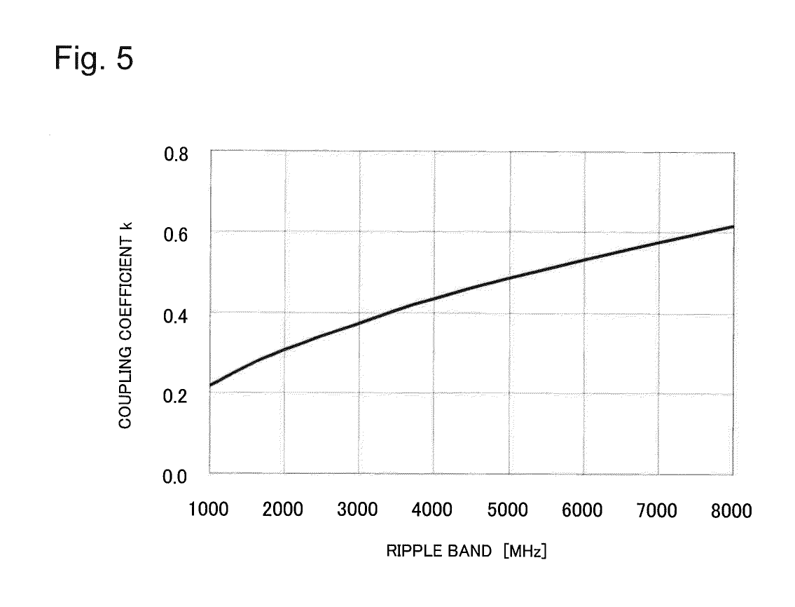

A concrete example of an operation to be performed when some of the coupling plates that determine a coupling coefficient are cut is described. In this example, a seven-stage band-pass filter using rectangular waveguides (3.1 mm×1.55 mm) in the frequency band of from 70 to 80 GHz is used. In data representing the concrete example, TE101 mode, which is one of the propagation modes of a rectangular waveguide, is used. FIG. 3 illustrates an example of a fin-line band-pass filter having an existing metal plate shape. FIG. 4A and FIG. 4B illustrate respectively partially enlarged views of a metal plate of the fin-line band-pass filter of the present invention, and of a metal plate of an existing fin-line band-pass filter.

First, a reason why the existing metal plate structure fails to implement a filter having a wide bandwidth is described. FIG. 5 illustrates a relationship between a ripple band and a coupling coefficient k required for the first coupling plate. The coupling coefficient in this example is the coupling coefficient used in a Chebyshev filter, and the filter has a frequency of 73.5 GHz. The coupling coefficient required for the first coupling plate (last coupling plate) is largest among the coupling coefficients that determine the bandwidth of the filter. Therefore, in this example, only the relationship between the ripple band and the coupling coefficient of the first coupling plate is described. For instance, in order to manufacture a filter, in which the center frequency is 73.5 GHz, seven-stage, and the ripple band is 6,000 MHz, it is necessary to set the coupling coefficient of the first coupling plate to 0.53. In order to obtain intended characteristics, it is necessary to satisfy the required coupling coefficient. Deviation from the required coupling coefficient may deteriorate the characteristics. In a fin-line filter, a structure that determines the coupling coefficient is a coupling plate.

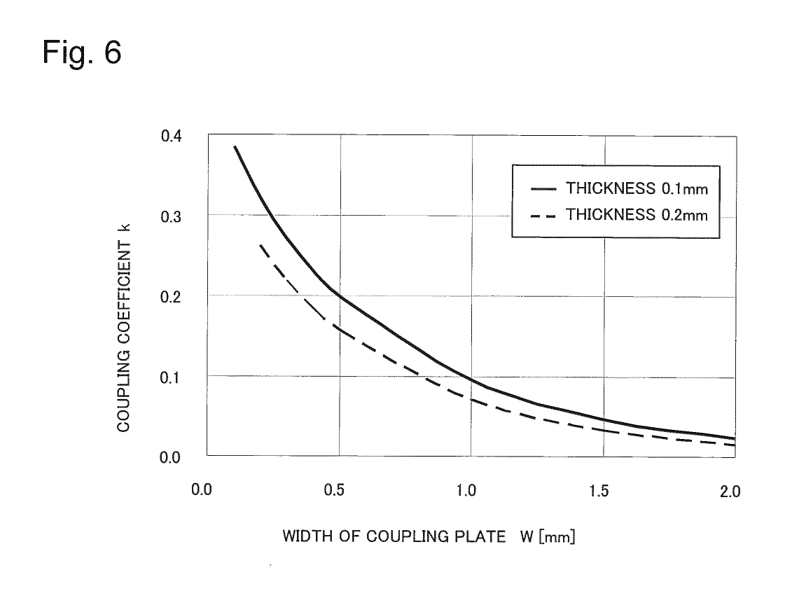

FIG. 6 illustrates a relationship between the width W of a coupling plate, and the coupling coefficient k in an existing structure. The width W of a coupling plate is illustrated in FIG. 4B. In FIG. 6, the solid line represents a structure, in which the thickness of a metal plate is set to 0.1 mm, and the dotted line represents a structure, in which the thickness of a metal plate is set to 0.2 mm. As the thickness of a metal plate decreases, and as the width of the metal plate decreases, the coupling coefficient increases. In view of the manufacturing constraints, however, the lower limit of the width of a metal plate is substantially the same as the thickness of the metal plate. It is not possible to decrease the thickness of a metal plate to the limit in view of the strength of the metal plate. Taking into consideration the productivity in assembling or the like, the thickness of a metal plate is at most about 0.1 mm. The maximum allowable value of the coupling coefficient in this case is 0.39.

In implementing a band-pass filter, in which the center frequency is 73.5 GHz, seven-stage, and the ripple band is 6,000 MHz as exemplified above, the conventional structure fails to achieve the coupling coefficient of 0.53, regardless that 0.53 is necessary as the coupling coefficient of the first coupling plate (last coupling plate). In the existing structure, it is limited to the band-pass filter having a ripple band of 3,000 MHz or lower to be implemented. For the aforementioned reason, the existing metal plate structure fails to implement a filter having a wide bandwidth so that the coupling plate of the exemplary embodiment having a shape capable of increasing the coupling coefficient is advantageous.

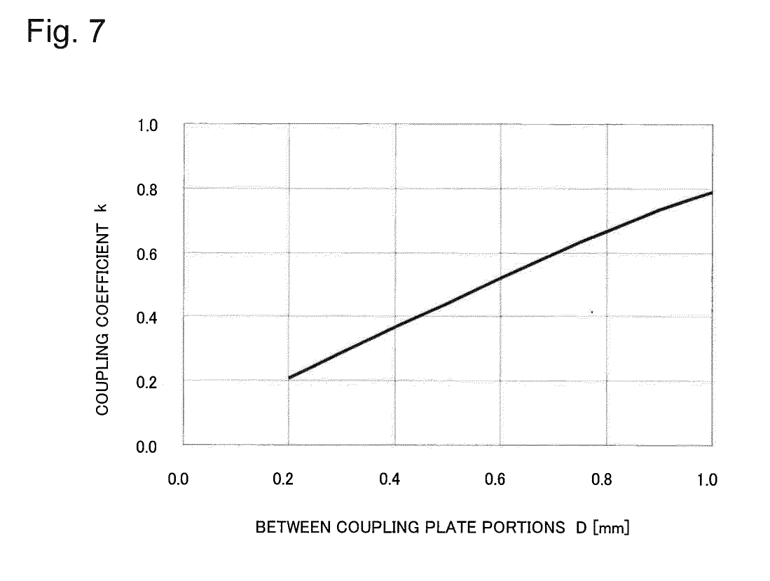

FIG. 7 illustrates a relationship between the gap D between coupling plate portions, and the coupling coefficient k. The gap D between coupling plate portions is illustrated in FIG. 4A. In this example, the width W of a metal plate is set to 1 mm. As the gap D between coupling plate portions increases, the coupling coefficient increases. Cutting some of the coupling plates that separate resonators from each other (separate a resonator from an external portion) makes it possible to strengthen the coupling between the resonators, and to increase the coupling coefficient. For instance, when the gap D between coupling plate portions is set to about 0.6 mm, the coupling coefficient becomes 0.53. Thus, it is possible to implement a band-pass filter having a ripple band of 6,000 MHz, which could not be implemented by the existing structure.

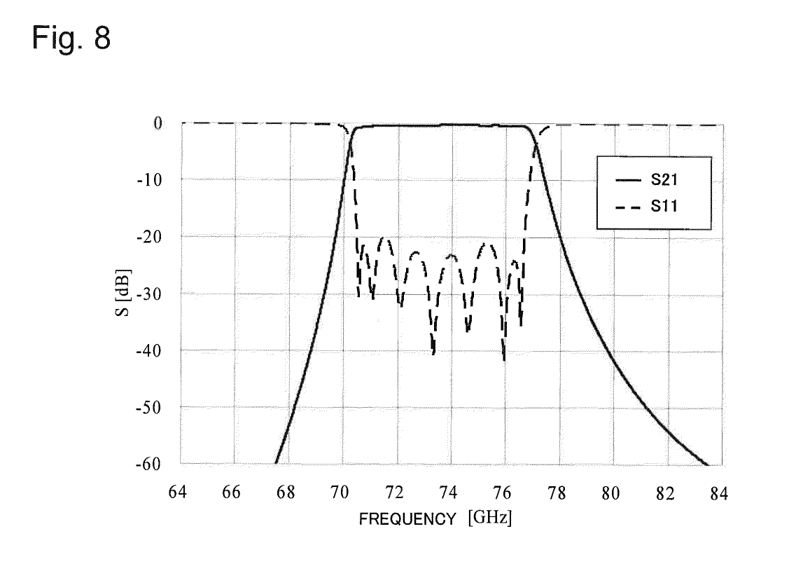

FIG. 8 illustrates characteristics of a fin-line band-pass filter designed with use of the structure of the exemplary embodiment. The solid line represents insertion loss S21, and the dotted line represents return loss S11. The filter has a metal plate, in which only the first coupling plate and the last coupling plate are cut. The filter provides enhanced characteristics. In this example, the characteristics of a filter, in which only the first coupling plate and the last coupling plate are cut among all the coupling plates including the first coupling plate and the last coupling plate, are described. Alternatively, a coupling plate or plates other than the first coupling plate and the last coupling plate may be cut depending on a required coupling coefficient. As described above, use of the structure of the exemplary embodiment makes it possible to implement a coupling coefficient that could not be implemented by the existing structure, and makes it possible to implement a filter of a wide bandwidth.

In the foregoing description, TE101 mode, which is one of the propagation modes of a waveguide, is used. Use of the exemplary embodiment makes it possible to configure a fin-line band-pass filter at a higher order mode, such as TE102 mode or TE103 mode. Use of a higher order mode is advantageous in creating a filter with less variation with respect to size error. When TE102 mode is used, sensitivity with respect to size error is reduced to half, as compared with the case of using TE101 mode. However, use of a higher order mode may increase the coupling coefficient necessary for implementing a filter having the same bandwidth. Therefore, use of the structure of the exemplary embodiment capable of implementing a larger coupling coefficient makes it possible to create a filter, in which a high order mode such as TE102 or T103 is used, and variation with respect to size error is small. Further, since variation with respect to size error is small, the necessity of adjusting the characteristics by using a screw is reduced, resulting in a cost reduction.

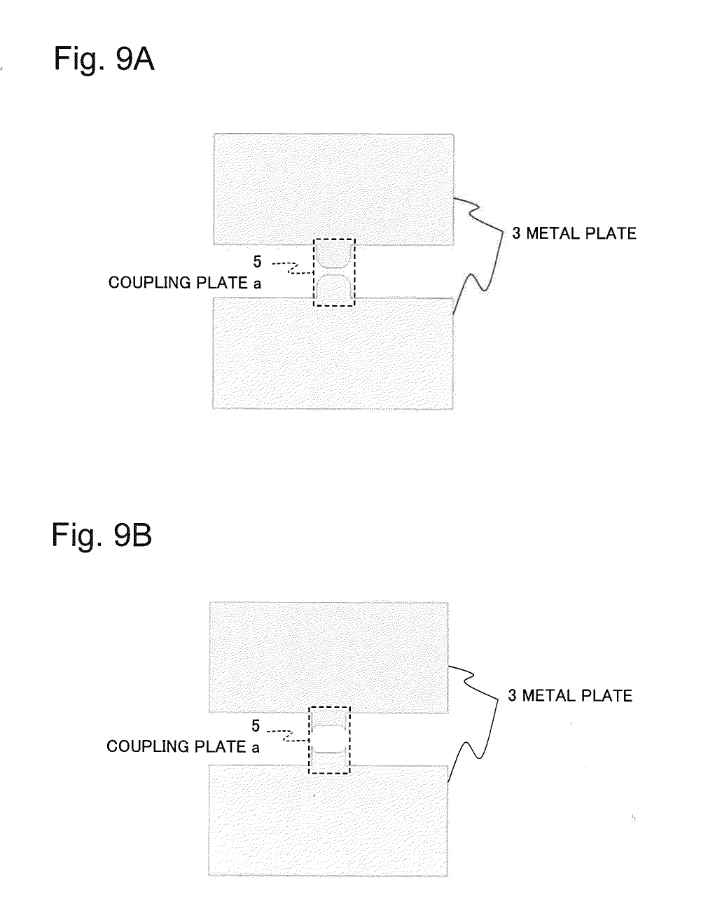

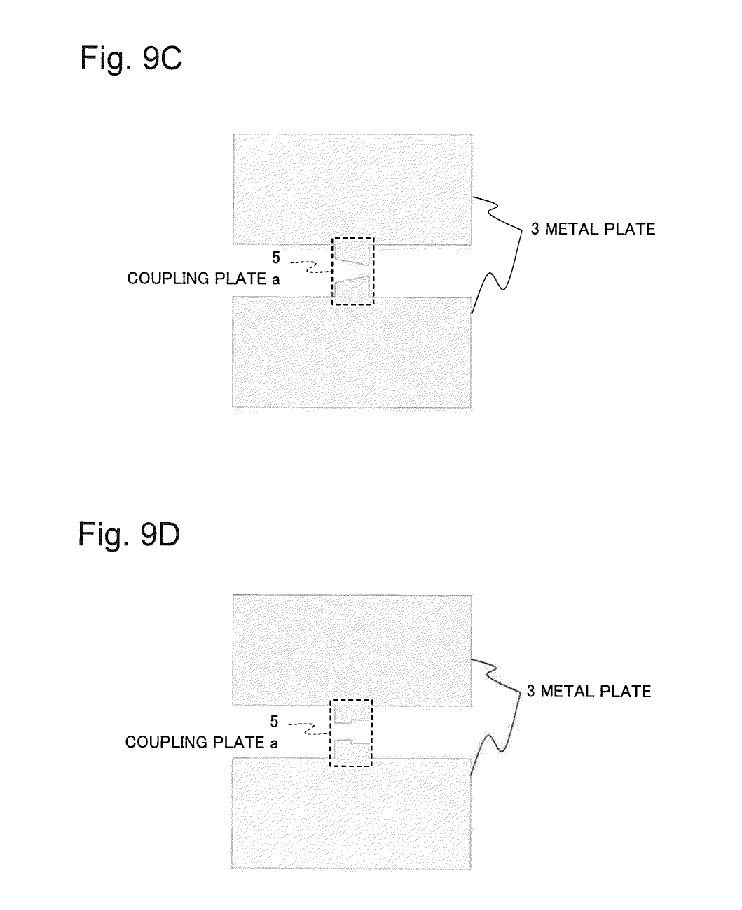

In the description of the fin-line band-pass filter of the exemplary embodiment, the number of stages of the filter used is seven. The number of stages of the filter is designed depending on a required pass-band and a required amount of attenuation, and does not limit the scope of the invention. Further, as illustrated in FIGS. 9A to 9D, it is possible to modify the cutting manner of a coupling plate a5. It is possible to secure the characteristics, even when the corner of the coupling plate a5 is rounded or the widths of both ends of the coupling plate a5 are different from each other.

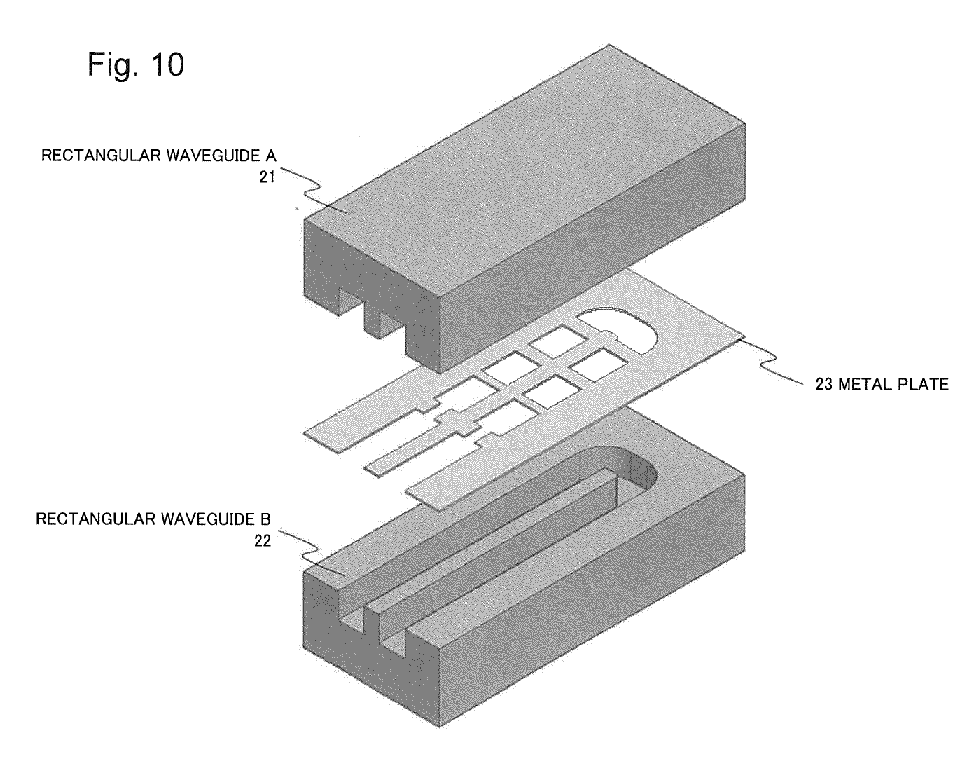

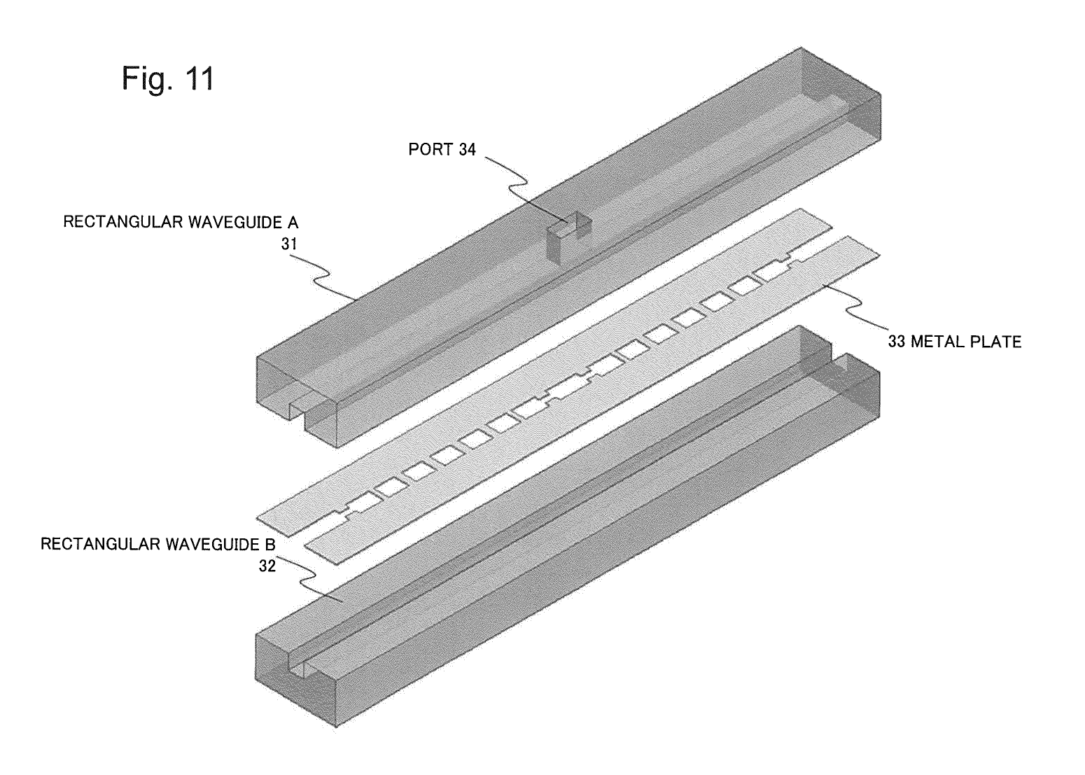

FIG. 10 is a diagram illustrating a configuration, in which the shape of a filter is modified. In this case, the invention is also applicable to a curved filter. The filter may not necessarily be a linear filter. Further, FIG. 11 is a diagram illustrating a duplexer configured with two filters and a T-junction. The band-pass filter having the structure of the present invention may also be applied to a duplexer or a multiplexer. The shape of the filter or the position of a port 34 is designed in conformity with the interface of a device, and does not limit the present invention.

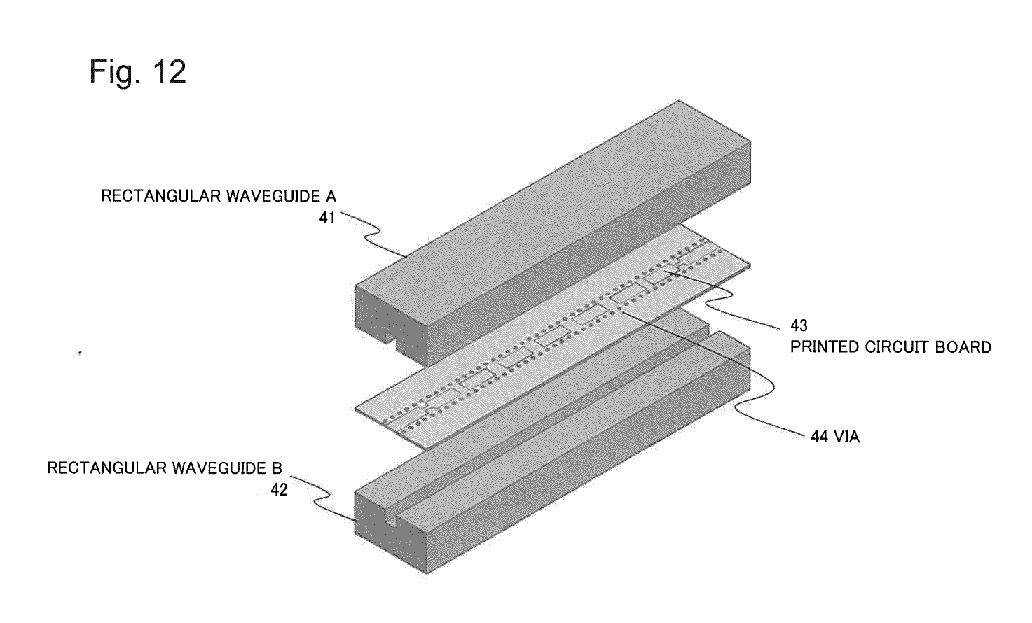

FIG. 12 is a diagram illustrating a configuration, in which a printed circuit board is used, in place of a metal plate. Forming coupling plates and resonators by a metal layer pattern on a printed circuit board 43 makes it possible to configure a fin-line band-pass filter in the same manner as in the case of using a metal plate. Use of a printed circuit board is advantageous in forming a filter, an amplifier, and the like on one substrate, which makes it easy to connect the members to each other. Use of a printed circuit board makes it possible to form a waveguide, a microstrip line converter, and the like on the printed circuit board.

According to the present invention, in view of the characteristics of the fin-line band-pass filter of the exemplary embodiment above mentioned, it is possible to increase the coupling coefficient. Therefore, it is possible to create a fin-line band-pass filter having a wide bandwidth. Further, it is possible to use a high order mode such as TE102 mode or TE103 mode, which makes it possible to create a filter with less variation with respect to size error. Furthermore, since variation with respect to size error is small, the necessity of adjusting the characteristics by using a screw is reduced. This is advantageous in reducing the cost. In addition, resonators can be formed of one plate, which makes it possible to shorten the assembling time, and the adjustment time using a screw. This is advantageous in reducing the cost.

The present invention is not limited to the foregoing exemplary embodiment and examples thereof, and may be modified in various ways as far as such modifications lie within the scope of the invention hereinafter defined. It is needless to say that such modifications lie in the scope of the invention.

This application claims the priority based on Japanese Patent Application No. 2012-196858 filed on Sep. 7, 2012, and all of the disclosure of which is hereby incorporated.

### INDUSTRIAL APPLICABILITY

The present invention relates to a fin-line band-pass filter for use in a microwave band or a millimeter wave band.

### REFERENCE SIGNS LIST

1, 21, 31, 41 Rectangular waveguide A
2, 22, 32, 42 Rectangular waveguide B
3, 23, 33 Metal plate
34 Port
4 Resonator
5 Coupling plate a
6 Coupling plate b
10 Fin-line band-pass filter
43 Printed circuit board
44 Via

1. A band-pass filter comprising:
rectangular waveguides separated from each other along a middle of a broad width surface of the filter; and
a metal plate interposed between the rectangular waveguides, wherein
at least one of coupling plates formed of the metal plate is cut.

2. The band-pass filter according to claim 1, wherein
the coupling plate formed on an end of the metal plate, among the coupling plates, is cut.

3. The band-pass filter according to claim 1, wherein
the two coupling plates formed on both ends of the metal plate, among the coupling plates, is cut.

4. The band-pass filter according to claim 1 wherein
a portion of the cut coupling plate has a linear shape.

5. The band-pass filter according to claim 1, wherein
a portion of the cut coupling plate has a curved shape.

6. The band-pass filter according to claims 1, wherein
a portion of the cut coupling plate has a step shape.

7. A band-pass filter comprising:
curved waveguides separated from each other along a middle of a broad width surface of the filter; and
a metal plate interposed between the curved waveguides, wherein at least one of coupling plates formed of the metal plate is cut.

8. The band-pass filter according to claim 7, wherein
the curved waveguide has a U-shape.

9. A band-pass filter comprising:
a plurality of filter elements connected to each other, wherein
each of the filter elements is provided with a band-pass filter of claim 1.

10. The band-pass filter according to claim 1, wherein
the metal plate is formed of a metal layer pattern on a printed circuit board.
